(19) United States
(12) Patent Application Publication
(10) Pub. No.: US 2003/0036951 A1
(43) Pub. Date: Feb. 20, 2003

(54) Articles of manufacture and marketing methods

(76) Inventors: Quintin T. Phillips, Boise, ID (US); Eric D. Debourse, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/932,237

(22) Filed: Aug. 16, 2001

(51) Int. Cl. G06F 17/60

(52) U.S. Cl. 705/14

(57) ABSTRACT

Marketing methods, and articles of manufacture are described. According to one aspect, a marketing method to image forming device users includes providing a consumable usable in an image forming device to form hard images and usable to enable a marketing function with respect to image forming device users; making available the marketing function to other parties apart from a provider of the consumables; receiving an indication regarding a desirous party to utilize the marketing function; enabling a marketing function for the desirous party using the consumable; and initiating the marketing function after the enabling.

### FIELD OF THE INVENTION

The invention relates to articles of manufacture and marketing methods.

### BACKGROUND OF THE INVENTION

Companies are increasingly attempting to break into and/or enhance a percentage of the market for their product. Marketing to individuals as well as business to business (B2B) selling provides numerous opportunities for increasing sales or market percentage. However, despite the advantages of aggressive marketing, techniques for effective marketing are limited, especially marketing to specific targets or groups of consumers.

Targeted marketing is a valuable tool in providing relevant marketing messages to consumers. Users of printers and other image forming devices comprise a specific market which has relevant marketing appeal to suppliers of various product, related and unrelated to printers or other image forming devices. For example, it may be desired to send targeted marketing messages for electronic devices and accessories related to imaging jobs as well as other electronic devices to users of printers.

Problems with successful targeted marketing include identification of relevant portions of the population for which marketing messages will have significant, effective impact. In addition, there are challenges to convey the message to such an audience in a relatively unobtrusive and non-offensive manner. Furthermore, it is advantageous to provide marketing messages without requiring substantial action by the audience.

A need exists to provide improved systems and methodologies for implementing marketing techniques.

### SUMMARY OF THE INVENTION

The present invention relates to articles of manufacture and marketing methods.

According to one aspect, a marketing method to image forming device users comprises providing a consumable usable in an image forming device to form hard images and usable to enable a marketing function with respect to image forming device users; making available the marketing function to other parties apart from a provider of the consumables; receiving an indication regarding a desirous party to utilize the marketing function; enabling a marketing function for the desirous party using the consumable; and initiating the marketing function after the enabling.

Another aspect provides an article of manufacture comprising: a processor-usable medium having processor-useable code embodied therein and configured to cause processing circuitry to perform steps comprising: providing a marketing message intended for an image forming device user from a party other than a provider of a consumable; monitoring an association of a consumable with an image forming device; enabling communication of the marketing message to the image forming device user responsive to the monitoring.

Yet another aspect of the invention provides a marketing method to printer users comprising: providing a consumable usable in a printer to print hard images and usable to enable communication of a marketing message with respect to printer users; offering the contents of the marketing message to other parties apart from a provider of the consumables; receiving an indication regarding a desirous party to utilize the marketing message; enabling a marketing message for the desirous party using the consumable and wherein the marketing message is unrelated to the printer and unrelated to the consumable; detecting a triggering event with respect to the consumable after the associating; and initiating communication of the marketing message using the printer responsive to the detecting.

Additional aspects are also provided, some of which are described in further detail below.

Other features and advantages of the invention will become apparent to those of ordinary skill in the art upon review of the following detailed description, claims, and drawings.

### DESCRIPTION OF THE DRAWINGS

FIG. 1 is an illustrative representation of an exemplary image forming system and a marketing system.

FIG. 2 is a functional block diagram of components of an exemplary image forming device.

FIG. 3 is a functional block diagram of components of an exemplary marketing system.

FIG. 4 is a flow chart of an exemplary methodology executable within the marketing system.

FIG. 5 is a flow chart of an exemplary methodology executable within the image forming device.

FIG. 6 is a flow chart depicting another exemplary methodology executable within the image forming device.

FIG. 7 is a flow chart depicting another exemplary methodology executable within the marketing system.

### DETAILED DESCRIPTION OF PREFERRED EMBODIMENTS

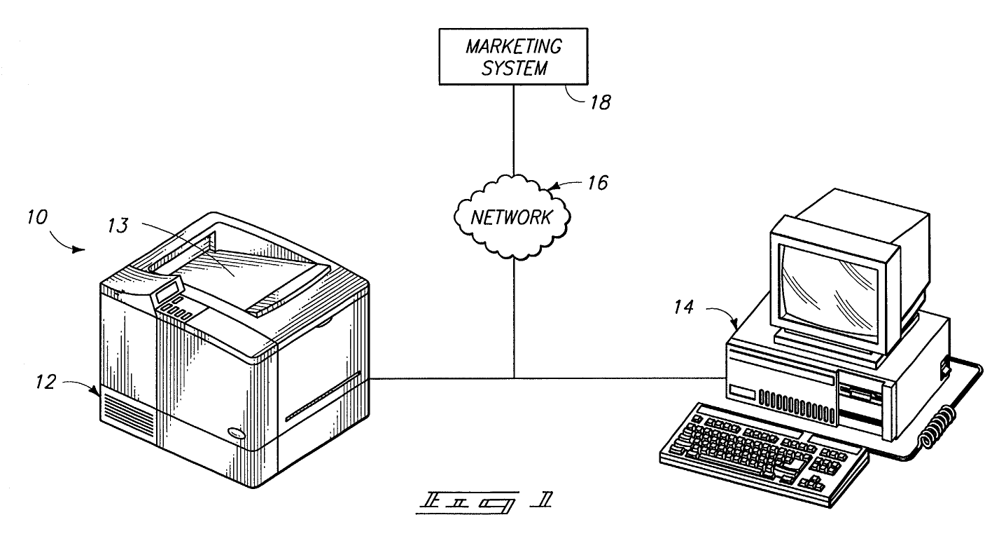

FIG. 1 depicts an image forming system 10 including one or more image forming device 12 and one or more host device 14 (only one device 12 and one device 14 are depicted in FIG. 1). Image forming system 10 is coupled with a marketing system 18 in the depicted arrangement.

One or more of image forming device 12, host device 14 and marketing system 18 are configured to communicate with one another using an appropriate communication medium comprising a network 16, for example. Exemplary networks 16 utilized to implement such communications include a public network (e.g., the Internet) and/or a private network. For example, image forming device 12, host device 14 and marketing system 18 are configured to implement Web communications via network 16 in one embodiment.

In typical arrangements, a plurality of image forming devices 12 and host devices 14 communicate with marketing system 18 using one or more network 16. More specifically, operations of marketing system 18 may be performed with respect to a plurality of image forming devices 12. In addition, a plurality of image forming devices 12 may be configured to implement operations described herein and to communicate with one or more marketing system 18 to implement such marketing operations.

Image forming device 12 is configured to utilize one or more consumable to form hard images. Exemplary consumables utilized within a given image forming device include imaging media (e.g., paper, transparencies, etc.), marking agents (e.g., toner), components having fixed life spans (e.g., developer assembly) and other expendable items utilized to complete desired jobs. Aspects of the present invention provide marketing to users of image forming devices in conjunction with utilization of consumables within such image forming devices.

Exemplary image forming devices 12 include printers, facsimile devices, copiers, multiple-function devices or other devices capable of forming hard images upon media 13, such as paper, labels, transparencies, roll media, etc. Exemplary hard images include images provided upon output media comprising printed media in one example.

An exemplary host device 14 is implemented as a personal computer having an Intel™ processor or AMD™ processor (not shown). Host device 14 provides data to be imaged to image forming device 12. In addition, host device 14 may be associated with a user of image forming device 12 and/or other personnel, such as a system administrator, who monitors or otherwise accesses image forming device 12. Other host device 14 configurations are possible.

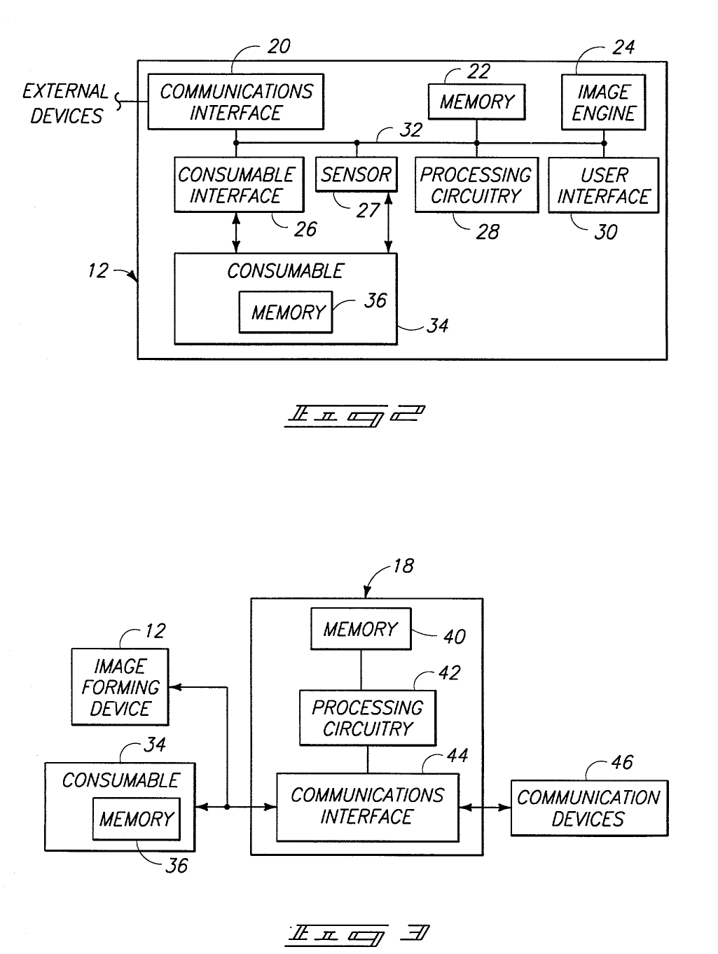

Referring to FIG. 2, components of an exemplary image forming device 12 are illustrated. Some of the depicted components are optional and other arrangements of image forming device 12 configured to form hard images are possible. The exemplary embodiments disclosed herein are discussed with reference to a printer application although the present invention applies to any image forming device configuration capable of forming hard images.

As shown, the exemplary image forming device 12 includes a communications interface 20, a memory 22, an image engine 24, a consumable interface 26, a sensor 27, processing circuitry 28, a user interface 30 and a bus 32. Bus 32 is configured to implement communications intermediate the respective coupled components of image forming device 12.

Communications interface 20 is configured to couple with a communication medium, including for example network 16, to implement communications with external devices including host device 14 and marketing system 18. An exemplary communication interface 20 comprises a network interface card (NIC), modem or other configuration configured to implement external communications with respect to image forming device 12.

Memory 22 comprises computer usable media configured to store executable instructions configured to cause processing circuitry 28 to perform steps regarding marketing to an image forming device user in accordance with aspects of the present invention. Memory 22 is configured to store digital information and instructions usable to control operations within image forming device 12. For example, memory 22 is configured to store image data to be imaged using image engine 24, executable instructions usable by processing circuitry 28 to implement imaging operations and to control operations of image forming device 12 including marketing operations described herein, as well as other digital data to be stored within image forming device 12. Memory 22 comprises a hard disk, floppy disk, CD ROM, random access memory (RAM), read only memory (ROM) and/or flash memory in but one exemplary embodiment. Other configurations of memory 22 are possible.

Image engine 24 implements formation of hard images upon media 13. According to the exemplary described printer embodiment, image engine 24 is implemented as a print engine. An exemplary print engine includes a developing assembly and a fusing assembly (not shown) to respectively develop hard images using marking agents and to affix the marking agents to media 13. Other constructions or embodiments of image engine 24 are possible.

Consumable interface 26 is configured to couple with a consumable 34. For example, in one embodiment, consumable interface 26 is arranged to establish an electrical coupling for bidirectional communications of digital data with respect to consumable 34. In one example, consumable 34 includes a memory device 36 and digital data may be written to or read from memory device 36 via consumable interface 26. One example of consumable 34 including memory device 36 is implemented as a toner cartridge containing toner for use within image forming device 12 and an integrated circuit memory device. U.S. Pat. No. 5,491,540, incorporated herein by reference, discusses exemplary communications between an image forming device and a consumable. Other systems or methods may be utilized to implement communications with a consumable.

In one example, memory device 36 of consumable 34 is configured to electrically couple with consumable interface 26 upon insertion of consumable 34 into image forming device 12. Processing circuitry 28 reads and writes data with respect to memory device 36 using consumable interface 26. Other configurations of storing and accessing data upon a consumable 34 are possible.

A sensor 27 is configured to couple with a consumable 34 and to monitor the status thereof. For example, sensor 27 monitors a remaining amount of consumable 34. In another embodiment, sensor 27 monitors usage of consumable 34 to determine the status of consumable 34. In yet another embodiment, sensor 27 is omitted and processing circuitry 28 monitors usage of consumable 34 (e.g., monitors number of pixels imaged to approximate usage of toner) to determine the status of consumable 34. Other sensing operations or structures are possible.

Processing circuitry 28 is configured to execute executable instructions to control operations of image forming device 12 and to implement marketing operations described herein according to aspects of the invention. Processing circuitry 28 is configured to execute executable instructions stored within memory 22 and comprising, for example, software and/or firmware instructions. Exemplary processing circuitry 28 is implemented as a microprocessor in but one embodiment.

According to aspects of the present invention, processing circuitry 28 is configured to function in conjunction with other appropriate components of device 12 as an embedded web server configured to communicate with external devices such as host device 14 and marketing system 18 or other external devices. Exemplary embedded web server operations of an image forming device are described in U.S. Pat. No. 5,956,487, incorporated herein by reference. Other configurations for implementing external communications with respect to image forming device 12 are possible.

User interface 30 is implemented as a control panel and a display (the control panel and display are not shown) in one exemplary embodiment. A user can input commands via the control panel and processing circuitry 28 controls the display to depict status and other messages pertinent to image forming device 12.

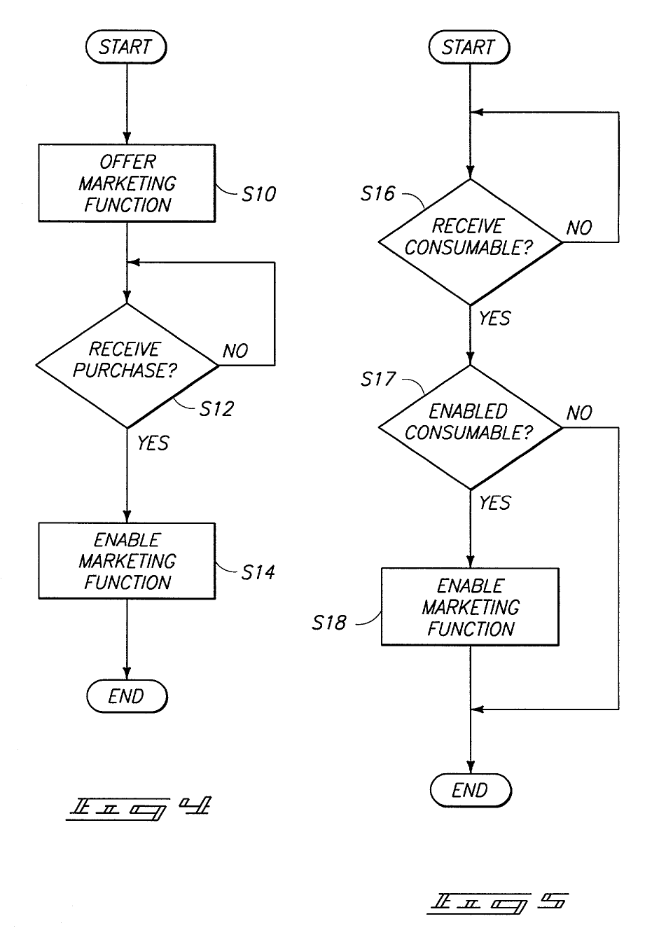

Referring to FIG. 3, exemplary components of marketing system 18 are depicted. In the illustrated arrangement, marketing system 18 includes a memory 40, processing circuitry 42, and a communications interface 44.

Marketing system 18 may be associated with any party interested in providing marketing or making available marketing functions to users of image forming devices 12. Exemplary parties include manufacturers of consumables, suppliers of consumables, resellers of consumables, or other parties interested in implementing or making available marketing functions. The marketing functions may or may not relate to consumables or image forming devices.

Memory 40 is configured to store executable instructions configured to cause processing circuitry 42 to perform various steps, some of which are described herein. Memory 22 may be implemented in one or more of a hard disk, disk drive, random access memory (RAM), read only memory (ROM) and/or flash memory or in any other arrangement configured to store executable instructions which may be utilized by associated processing circuitry 42 or other computer. In the described embodiment, memory 40 is configured to store software and/or firmware instructions to control operations of marketing system 18.

Processing circuitry 42 is configured to access executable instructions within memory 40 and to selectively store and retrieve digital data with respect to memory 40 as desired. An exemplary configuration of processing circuitry 42 is implemented as a microprocessor, commonly available from Intel™ or AMD™. Processing circuitry 42 is configured as a web server in one arrangement.

Communications interface 44 is configured to implement communications of marketing system 18 with externally located devices. An exemplary communications interface 44 is implemented as a network interface card, modem or other device capable of implementing communications between marketing system 18 and external devices. In the depicted example, communications interface 44 is configured to couple with image forming device 12, and communication devices 46 associated with other parties possibly interested in utilizing marketing functionality according to aspects of the present invention. Exemplary communication devices 46 include personal computers or servers of such parties. Communications of marketing system 18 with one or image forming device 12 and communication devices 46 may be implemented using network 16.

Consumables 34 are usable within image forming devices 12 to form hard images as described above. According to aspects of the present invention, consumables 34 are usable to enable marketing functions with respect to users of such image forming devices 12 or other persons. Utilization of consumables to enable some of the marketing operations provides targeted marketing to such users of consumables.

To implement some marketing aspects of the invention, it is desired to advertise or otherwise make known the availability of the marketing functions enabled by the devices and methodologies described herein. For example, it may desired by businesses associated with imaging devices or consumables, or business not associated with imaging devices or the consumables to advertise to users of image forming devices 12. Such businesses may be identified and targeted to inquire whether there is an interest in marketing using marketing system 18. Capabilities of marketing system 18 are made available to such businesses or individuals. For example, space upon memory device 36 of one or more consumable 34 is made available to interested parties to implement marketing functions disclosed herein.

In one example, marketing system 18 sends appropriate inquiry messages to communication devices 46, comprising for example, personal computers, web servers, etc. to determine any interest in utilizing marketing services of marketing system 18. Processing circuitry 42 may formulate such messages in any appropriate format for communication, including communication using network 16, to communication devices 46.

Responsive to such inquires, marketing system 18 awaits receipt of responses to the inquiries. For example, marketing system 18 is configured to receive indications from desirous parties interested in utilizing marketing functions of the present invention. Following such indication, marketing techniques may be specifically tailored to the interested parties.

Once the marketing interest is identified, marketing system 18 operates to enable marketing functions for the desirous party. According to some aspects of the invention, consumables 34 are utilized to implement the marketing functions. Marketing functions according to aspects of the present invention are initiated with the aim of effectively marketing to users or other personnel associated with image forming devices 12. As described below, various triggering events are utilized to initiate marketing aspects of the invention.

Marketing system 18 enables consumables 34 to implement the desired marketing functions in one implementation of the invention. The enablement of consumable may be performed within the factory before shipment of the consumable 34 or at other convenient times before the consumables reach end users, including for example individuals or businesses, which will utilize the consumables 34.

Exemplary enablement of consumables 34 by marketing system 18 includes programming information upon memory 36 which may be utilized to implement marketing functionality according to aspects of the invention. The specific programming or providing of information upon memory 36 may be implemented in a plurality of formats as described herein.

In the described arrangement, marketing system 18 is utilized to properly program memory devices 36 of consumables 34. Thereafter, and according to some aspects, marketing system 18 monitors and communicates with image forming devices 12 having the programmed consumables 34 to implement some of the marketing functions. The programming functionality of consumables 34 and the communication functionality of marketing system 18 with image forming devices 12 may be implemented using distinct different systems or hardware in other arrangements (e.g., one system programs consumables 34 while another separate system performs monitoring and/or communication operations with respect to image forming devices 12 using such consumables 34).

According to one aspect of the invention, consumable 34 is configured to enable a marketing function comprising communication of a marketing message associated with the desirous party to users of image forming devices 12. In one arrangement, communications interface 44 and memory 36 are electrically coupled, processing circuitry 42 formulates a desired marketing message typically with assistance from the desired parties interested in marketing and stores the formulated marketing message upon memory device 36. The marketing message is stored in a format accessible by appropriate processing circuitry 28 of an image forming device 12 which subsequently controls device 12 to communicate the message.

According to other aspects of the present invention, it may be desired to minimize the amount of memory 36 dedicated to marketing operations to allow room for the storage of historical data regarding consumable usage, image forming device history information or for other uses. According to this arrangement, a specific identifier (e.g., code) instead of an entire message is stored within memory 36. At an appropriate time, an image forming device 12 extracts the identifier from a consumable 34 coupled therewith. The identifier is utilized to retrieve an appropriate respective marketing message corresponding to the code and the desirous party.

For example, image forming device 12 extracts the identifier from memory device 36 and communicates the identifier externally of image forming device 12 to identify an appropriate marketing message associated with the identifier and the desirous party. In one embodiment, processing circuitry 28 formulates a message including the identifier for communication to marketing system 18. Marketing system 18 receives the identifier communicated from image forming device 12 and subsequently takes action to forward a desired marketing message corresponding to the identifier to image forming device 12 for appropriate communication to the user.

In one possible arrangement, memory 40 of marketing system 18 stores a plurality of marketing messages. Upon receipt of an identifier, processing circuitry 42 extracts the appropriate marketing message using the identifier and encapsulates the marketing message for communication back to image forming device 12. Image forming device 12 thereafter appropriately communicates the marketing message to appropriate individuals using device 12.

According to another aspect of the invention, a condition of the consumable status may be stored within memory device 36 of consumable 34. Upon association of consumable 34 with an image forming device 12, image forming device 12 extracts the condition and monitors status of consumable 34 utilizing sensor 27. Exemplary predetermined statuses stored within memory 36 include a “toner low” status, “toner out” status, or other desired status. Utilizing sensor 27, processing circuitry 28 monitors the status of consumable 34 and compares such actual status with the consumable status stored upon memory 36. Upon matching of the status of consumable 34 with the predetermined status programmed in memory 36, processing circuitry 28 communicates a request to marketing system 18 which identifies an appropriate marketing message associated with the consumable 34. Upon receipt of the request, processing circuitry 42 extracts a desired marketing message from memory 40 and communicates the marketing message to image forming device 12 for appropriate communication to the user using device 12.

According to another aspect, following installation or other association of consumable 34 with an image forming device 12, the image forming device 12 notifies marketing system 18 of the coupling. Thereafter, marketing system 18 interrogates the respective image forming device 12 for the consumable status. In particular, processing circuitry 28 of the image forming device 12 monitors the status of the consumable 34 using sensor 27 and responsive to interrogation from marketing system 18 forwards the status information to marketing system 18. Thereafter, marketing system 18 forwards the appropriate message to respective image forming device 12 for communication to the user at an appropriate time and corresponding to image forming device 12 communicating an appropriate status. Other aspects according to the present invention for conveying marketing messages to users responsive to utilization of consumables 34 are possible.

As described above, a variety of occurrences or operations are utilized to trigger marketing operations according to aspects of the invention. For example, the association (e.g., installation or coupling) of a consumable 34 with an image forming device 12 may be utilized to initiate marketing operations or functions including communication of messages to users.

Additionally, triggering events may occur after the association of a consumable 34 with an image forming device. For example, the status of consumable 34 may be utilized to trigger marketing functions of the invention. Such triggering events are exemplary and other triggering events are possible.

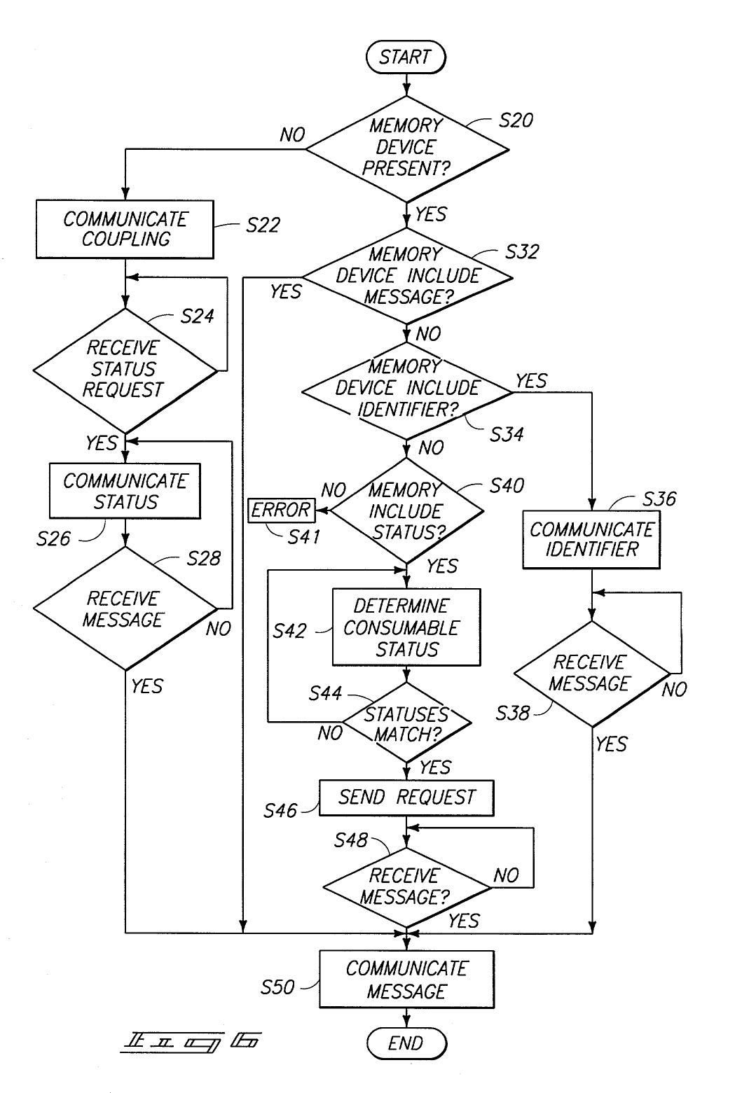

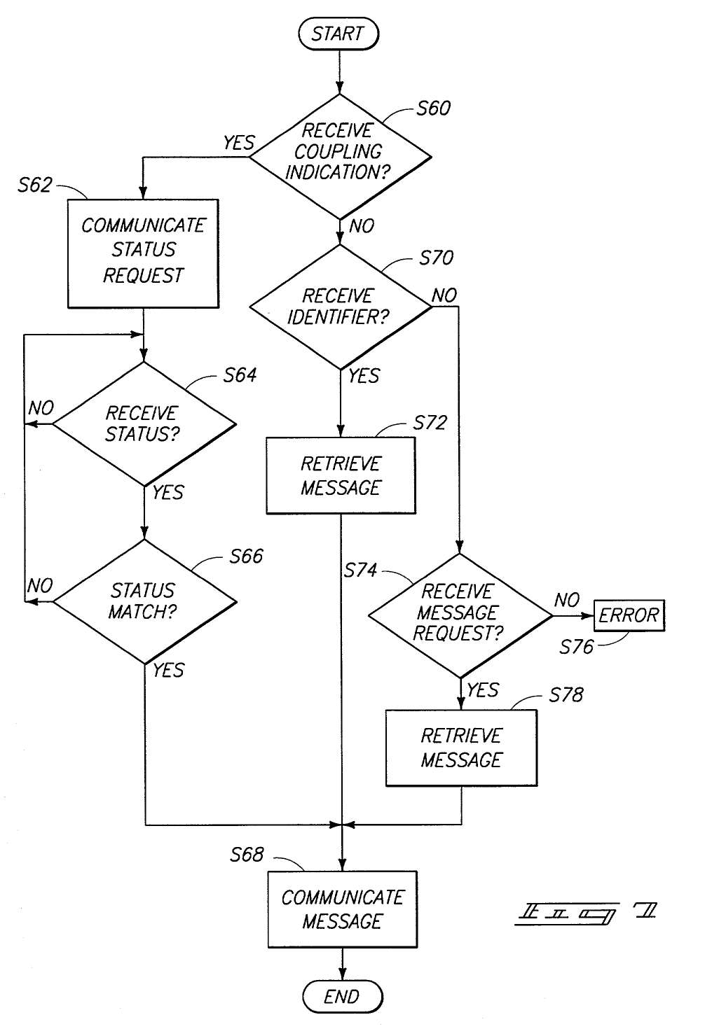

Referring to FIGS. 4-7, exemplary methodologies are depicted according to aspects of the present invention. Processing circuitry 28 of image forming device 12 executes the methodologies of FIGS. 5 and 6 and processing circuitry 42 of marketing system 18 implements the methodologies of FIGS. 4 and 7. Other methods embodying aspects according to the invention are possible. In addition, steps depicted in FIGS. 4-7 are omitted according to other methods of the invention.

Executable instructions configured to cause the respective processing circuits 28, 42 to perform the illustrated methodologies and other methodologies to implement aspects of the invention may be stored within appropriate computer usable medium. In accordance with aspects of the invention, such processor-usable code may be provided via articles of manufacture including memory devices 22, 40 and embodied as any appropriate processor-usable medium configured to store executable instructions and comprising, for example, RAM, ROM, flash memory, floppy disk, hard disk, zip disk, CD-ROM, etc., or alternatively embodied within a transmission medium, such as a carrier wave, and communicated via a network, such as the Internet.

Referring specifically to FIG. 4, association of parties desirous of utilizing the marketing functions of the invention with consumables 34 is described. In the described exemplary method, once space upon respective memory devices 36 is designated or otherwise made available, such space is offered to parties possibly interested in marketing. At a step S10, processing circuitry 42 is configured to communicate messages to communication devices 46 associated with other parties apprizing them of availability of marketing functionality according to aspects of the present invention. Alternatively, other methods may be utilized to solicit or apprize the other parties of such availability.

At a step S12, processing circuitry 42 monitors for the reception of a purchase of space of a memory device 36 of one or more consumable 34. In addition, inquiries regarding such marketing operations may be received in step S12 to stimulate negotiations between operators of marketing system 18 or other parties offering the available marketing functionality and the other parties interested in marketing hopefully to culminate in the purchase of space of memory devices 36 of consumables 34.

Once other parties desiring of utilizing the marketing aspects of the invention are indicated, marketing system 18 proceeds to enable marketing functions at a step S14 according to aspects of the invention. Exemplary enablement operations of step S14 include storage of information upon a memory device 36 of one or more appropriate consumable 34. Such stored information includes messages, identifiers, consumable status, codes and/or any other information utilized to implement the marketing aspects of the present invention, some of which are described herein.

Referring to FIG. 5, exemplary operations are discussed with respect to image forming device 12.

At a step S16, processing circuitry 28 monitors for the insertion or other coupling of a consumable with the device 12.

Processing circuitry 28 proceeds to a step S17 following the detection of the coupling of the consumable to determine whether the consumable is enabled for marketing operations. Such enablement may be determined by reading memory device 36, polling the user of image forming device 12 or using other methods.

If the condition of step S17 is negative, then imaging operations may proceed as in conventional imaging operations.

Alternatively, processing circuitry 28 proceeds to a step S18 if the condition of step S18 is affirmative to enable marketing functions according to aspects of the present invention and as described in exemplary embodiments with respect to FIG. 6.

FIG. 5 is optional, and in some implementations of the invention, the marketing functions of FIG. 6 and FIG. 7 are enabled without reference to FIG. 5 or without regard to analysis of the consumable as provided in step S17.

Referring to FIG. 6, operations within an image forming device 12 are described to implement marketing functions of the present invention.

Initially, processing circuitry 28 executes step S20 to determine whether a memory device is present within a consumable 34 received within image forming device 12.

If the condition of step S20 is negative, processing circuitry 28 proceeds to a step S22 to communicate a message to marketing system 18 indicating the coupling of consumable 34 with image forming device 12.

At a step S24, processing circuitry 42 awaits the reception of a status request from marketing system 18.

Processing circuitry 28 idles or performs other steps if the condition of step S24 is negative.

If the condition of step S24 is affirmative, processing circuitry 28 proceeds to a step S26 to communicate the status to marketing system 18.

At a step S28, processing circuitry 28 awaits the reception of a marketing message from marketing system 18. In the described embodiment, device 12 communicates status information to marketing system 18, and system 18 replies with a marketing message once the desired status of the consumable (e.g., consumable low) has reached a predetermined status as defined within system 18.

If the condition of step S28 is negative, processing circuitry 28 returns to step S26 to communicate updated status of consumable 34 as being monitored within device 12.

Alternatively, if the condition of step S28 is affirmative indicating receipt of a marketing message from system 18, processing circuitry 28 communicates the message at step S50.

Processing circuitry 28 communicates marketing messages in one or more desired format. For example, processing circuitry 28 communicates the message using image engine 24 to form hard images including the message, using a display within user interface 30, using an electronic message to host device 14 or other recipient, and/or according to other desired communication formats.

Referring again to step S20, if the condition thereof is affirmative, processing circuitry 28 proceeds to step S32 to determine whether memory device 36 of consumable 34 includes a message. A marketing or other message may be provided within memory device 36 as described above.

If the condition of step S32 is affirmative, processing circuitry 28 proceeds to step S50 to communicate the message stored within the memory device 36.

Alternatively, if the condition of step S32 is negative, processing circuitry 28 proceeds to a step S34 to determine whether memory device 36 includes an identifier.

If the condition of step S34 is affirmative, processing circuitry 28 proceeds to a step S36 to communicate the identifier to marketing system 18 for utilization therein in accessing and returning an appropriate marketing message.

Processing circuitry 28 then proceeds to a step S38 to determine whether a marketing message has been received from marketing system 18 or from another source responsive to communication of the identifier. Marketing system 18 utilizes the communicated identifier to access a defined marketing message corresponding to the identifier and communicates the appropriate message to the respective image forming device 12.

At step S38, processing circuitry 28 idles or performs other operations until the message is received.

Following receipt of the message, processing circuitry 28 proceeds to step S50 to communicate the message using image forming device 12.

If the condition of step S34 is negative, processing circuitry 28 proceeds to a step S40 to determine whether the memory device 36 includes a status.

If not, the program may exit, an error message may be generated or other marketing operation may be performed (not shown).

Alternatively, if the condition of step S40 is affirmative, processing circuitry 28 proceeds to step S42 to determine the consumable status using sensor 27, internal calculations or other desired method.

At a step S44, processing circuitry 28 determines whether the determined or calculated consumable status matches the status within memory device 36.

If not, processing circuitry 28 returns to step S42.

Alternatively, processing circuitry 28 proceeds to send a request to marketing system 18 at a step S46 to stimulate the communication of a message from marketing system 18 inasmuch as the consumable has reached the desired status stored within memory 36.

Thereafter, processing circuitry 28 awaits reception of the message at step S48. Processing circuitry 28 idles at step S48 or performs other steps or operations until the message is received.

Following receipt of the appropriate message, processing circuitry 28 proceeds to step S50 to communicate the message using image forming device 12.

In an alternative method, statuses of consumable are communicated to marketing system 18 after step S42 and marketing system 18 implements consumable status comparison operations using status information from device 12 and communicates the message which is received at step S48 after the statuses match.

Referring to FIG. 7, an exemplary methodology executable by processing circuitry 42 of marketing system 18 is depicted. Such methodology corresponds to the methodology executed by image forming device 12 described in FIG. 6. Other methods are possible.

Initially, at a step S60, processing circuitry 42 monitors for the reception of a coupling indication from an image forming device indicating the installation of a consumable 34 described above with respect to step S22 of FIG. 6.

Processing circuitry 42 proceeds to a step 62 to communicate a status request regarding consumable 34 to the respective image forming device 12 if the condition of step S60 is affirmative.

Processing circuitry 42 thereafter awaits reception of the status at a step S64. Processing circuitry 42 idles or performs other processes until the appropriate status is received.

At a step S66, processing circuitry 42 determines whether the received status of consumable 34 matches a stored status within memory 40.

If the condition of step S66 in negative, processing circuitry 42 returns to step S64 until another status is received.

If the condition of step S66 is affirmative, processing circuitry 42 proceeds to communicate the desired message at a step S68 to the respective image forming device 12 for communication to the user. The appropriate message may be based upon an identifier of the specific image forming device 12 or consumable 34 which may be communicated above in step S22.

Referring again to step S60, processing circuitry 42 proceeds to a step S70 to determine if an identifier (e.g., see step S36 in FIG. 6) has been received from image forming device 12 if the condition of step S60 is negative.

If an identifier is indicated as having been received at step S70, processing circuitry 42 retrieves an appropriate message corresponding to the received identifier from memory 40 at a step S72. The identifier is associated with an appropriate message for a party desiring to market to the user of image forming device 12.

Processing circuitry 42 communicates the message at step S68.

If an identifier is not received at step S70, processing circuitry 42 proceeds to a step S74 to determine if a message request has been received corresponding to a request in step S46.

If the condition of step S74 is affirmative, processing circuitry 42 retrieves the appropriate message using an identifier of the communicating image forming device 12 or respective consumable 34 at a step S78.

Thereafter, and at step S68, processing circuitry 42 communicates the message to the appropriate image forming device 12.

If the condition of step S74 is negative, processing circuitry 42 may return an error message at a step S76 to request additional information from device 12 or perform other operations.

As mentioned above, the depicted methodologies are exemplary. Steps of the depicted methodologies may be combined or executed by different ones of image forming device 12, host device 14, and marketing system 18 according to additional marketing aspects of the invention.

The protection sought is not to be limited to the disclosed embodiments, which are given by way of example only, but instead is to be limited only by the scope of the appended claims.

What is claimed is:

1. An article of manufacture comprising:
a processor-usable medium having processor-useable code embodied therein and configured to cause processing circuitry to perform steps comprising:
providing a marketing message intended for an image forming device user from a party other than a provider of a consumable;
monitoring an association of a consumable with an image forming device; and
enabling communication of the marketing message to the image forming device user responsive to the monitoring.

2. The article of claim 1 wherein the monitoring comprises monitoring coupling of the consumable and the image forming device.

3. The article of claim 1 wherein the enabling comprises storing the marketing message upon a memory device of the consumable.

4. The article of claim 1 wherein the enabling comprises storing an identifier of the marketing message upon a memory device of the consumable.

5. The article of claim 1 wherein the enabling comprises communicating the marketing message to the image forming device.

6. The article of claim 1 wherein the providing comprises providing the marketing message comprising a message unrelated to the consumable and unrelated to the image forming device.

7. The article of claim 1 wherein the code is further configured to cause the processing circuitry to perform the step including offering the marketing message to parties other than providers of the consumable and the providing is responsive to the offering.

8. A marketing method to image forming device users comprising:
providing a consumable usable in an image forming device to form hard images and usable to enable a marketing function with respect to image forming device users;
making available the marketing function to other parties apart from a provider of the consumables;
receiving an indication regarding a desirous party to utilize the marketing function;
enabling a marketing function for the desirous party using the consumable; and
initiating the marketing function after the enabling.

9. The method of claim 8 wherein the initiating the marketing function comprises communicating a marketing message for the desirous party using the image forming device.

10. The method of claim 9 wherein the communicating comprises communicating the marketing message comprising a message unrelated to the consumable and unrelated to the image forming device.

11. The method of claim 8 wherein the initiating comprises communicating a marketing message using an image forming device.

12. The method of claim 8 further comprising detecting a triggering event with respect to the consumables and wherein the initiating is responsive to the detecting.

13 The method of claim 12 wherein the initiating comprises communicating a marketing message.

14. The method of claim 12 wherein the detecting the triggering event comprises detecting coupling of the consumable with an image forming device.

15. The method of claim 12 wherein the detecting the triggering event comprises detecting a condition of the consumable reaching a predetermined level.

16. The method of claim 8 wherein the providing the consumable comprises providing the consumable configured to enable the marketing function comprising communication of a marketing message associated with the desirous party, and the consumable comprises a memory device configured to store the marketing message, and the enabling comprises storing the marketing message using the memory device and the initiating comprises accessing the marketing message from the memory device and communicating the marketing message using the image forming device after the accessing.

17. The method of claim 8 wherein the consumable comprises a memory device, and the enabling comprises storing an identifier within the memory device to identify the marketing function for the desirous party, and the initiating comprises accessing the identifier, and further comprising:
associating the consumable with an image forming device;
first communicating the identifier externally of the image forming device to identify the marketing function comprising a marketing message for the desirous party after the associating;
receiving a marketing message within the image forming device responsive to the first communicating; and
second communicating the marketing message using the image forming device.

18. The method of claim 8 wherein the enabling comprises monitoring the consumable utilizing an external device with respect to the image forming device, and further comprising detecting a status of the consumable reaching a predetermined status, and wherein the initiating the marketing function comprises forwarding a marketing message to the image forming device utilizing the external device, and further comprising communicating the marketing message using the image forming device.

19. The method of claim 8 wherein the making available comprises offering space of a memory device of a consumable to the other parties.

20. A marketing method to printer users comprising:
providing a consumable usable in a printer to print hard images and usable to enable communication of a marketing message with respect to printer users;
offering the contents of the marketing message to other parties apart from a provider of the consumables;
receiving an indication regarding a desirous party to utilize the marketing message;
enabling a marketing message for the desirous party using the consumable and wherein the marketing message is unrelated to the printer and unrelated to the consumable;
detecting a triggering event with respect to the consumable after the associating; and
initiating communication of the marketing message using the printer responsive to the detecting.
